(19) United States
(12) Patent Application Publication
(10) Pub. No.: US 2010/0150064 A1
(43) Pub. Date: Jun. 17, 2010

(54) IP TUNNELING OPTIMISATION

(76) Inventor: Wassim Haddad, Boulder, CO (US)

Correspondence Address: ERICSSON INC., 6300 LEGACY DRIVE, M/S EVR 1-C-11, PLANO, TX, 75024, US

(21) Appl. No.: 12/526,575

(22) PCT Filed: Feb. 9, 2007
(86) PCT No.: PCT/EP07/51279

§ 371 Date: Feb. 25, 2010

(51) Int. Cl. H04W 4/00; H04L 29/06

(52) U.S. Cl. 370/328; 370/392

(57) ABSTRACT

A node arranged in use to communicate over an IP network, the node comprising means for receiving an IP packet either from a peer node or from a higher protocol layer within the node, means for XORing a header of the packet or part thereof with a pad to translate the header or part thereof, and means for sending the packet to a peer node or for delivering the packet to a higher protocol layer within the node.

### TECHNICAL FIELD

The present invention relates to IP tunnelling optimisation and in particular, though not necessarily, to the reduction of the packet header overhead otherwise introduced by IP tunnelling.

### BACKGROUND

Tunnelling is a mechanism used in IP transport networks to address a number of issues. Consider for example a mobile terminal communicating with a correspondent node via a wireless access network. As the mobile terminal roams across and between wireless access networks, a mechanism is required to ensure that packets sent from the correspondent node are able to reach the mobile node. Mobile IPv6 is an IETF protocol which addresses this problem and which defines a bidirectional tunnelling (BT) mode which routes IP traffic exchanged between a mobile node and a correspondent node through a Home Agent which is located in a home network of the mobile node.

The BT mode defines as a “care-of-address” (CoA) the current location of the mobile node. It also makes use of a static home address (HoA) which is allocated to the mobile node and which peer terminals use to communicate with the mobile node (in the absence of any route optimisation mechanism). The home address causes packets to be routed from the correspondent node to the Home Agent, which forwards the packets to the mobile node at the care-of-address. A packet to be sent by the mobile node includes an inner or “real” header containing as the source address the mobile node's home address and as the destination address the correspondent node's address (CN). In addition, the mobile node adds an outer or “extra” header containing as the source address the mobile node's care-of-address and as the destination address the Home Agent's address (HA). The sent packet thus has the following structure (with a number of fields omitted from the headers for simplicity):

{MNs CoA, MN's HA} {MN's HoA, CN} {data}

The packet is thus routed first to the Home Agent. The Home Agent strips off the outer header and forwards the packet onwards towards the correspondent node. For packets sent from the correspondent node to the mobile node, the correspondent node will include only a single header containing as source address its address, and as destination address the mobile node's home address. Upon receipt of a packet at the Home Agent, the Home Agent again adds an outer header, containing as a source address the Home Agent's address and as the destination address the mobile node's care-of-address. Upon receipt of the packet at the mobile node, the node strips off the outer header and forwards the packet to higher protocol layers.

A significant disadvantage with tunnelling mechanisms is the packet size overhead which results from the additional outer header. In the BT mode, the overhead is equal to at least two IPv6 addresses. This means that the mobile node has to send an additional set of 256 bits each time it transmits a data packet to a correspondent node. The impact of the packet overhead can be very significant on battery life in the case of a mobile wireless terminal. It has been shown that wireless transmission of a single bit can require over 1000 times more energy than a single 32-bit computation and as such it is desirable to trade data transmission volume for computational effort if possible. A further disadvantage of tunnelling is of course the increased use of potentially scarce bandwidth.

A third issue arising from the use of tunnelling relates to data confidentiality and privacy. For example, a mobile node may wish to hide its home address (HoA) and even the address of the correspondent node (CN) from eavesdroppers on the link between the mobile node and the Home Agent. However, this is not possible with current tunnelling mechanisms such as MIPv6 BT mode. Providing identity privacy and data confidentiality protection should not increase the data packet size (otherwise the packet overhead related problems discussed above will be exacerbated) nor degrade the performance of the Home Agent.

The hierarchical MIPv6 (HMIPv6) represents an enhancement to the MIPv6 protocol. In particular, HMIPv6 provides a more signalling efficient approach which handles local mobility differently from global mobility. Nonetheless, similar tunnelling related problems arise with HMIPv6 and also with other tunnelling based protocols such as FMIPv6 and SHIM6.

### SUMMARY

It is an object of the present invention to provide a means for allowing the tunnelling of IP packets without, or with minimal, packet header overhead. It is also an object of the present invention to reduce the overhead associated with mobility related protocols.

According to a first aspect of the present invention there is provided a node arranged in use to communicate over an IP network, the node comprising:
means for receiving an IP packet either from a peer node or from a higher protocol layer within the node;
means for XORing a header of the packet or part thereof with a pad to translate the header or part thereof; and
means for sending the packet to a peer node or for delivering the packet to a higher protocol layer within the node.

Embodiments of the invention provide a quick and computationally simple mechanism for translating packet headers and more particularly for translating an IP address or addresses within packet headers. The invention is applicable in particular to address translation at mobility layers. Embodiments of the invention provide a mechanism whereby data within the header, or elsewhere in a packet, which does not require translation is left unchanged, merely by inserting zeros as appropriate in to the packet or packet header.

According to one embodiment of the invention, the node is one of a mobile node and a tunnelling node, packets being routed through the tunnelling node to and from a peer node of the mobile node. In this case, the tunnelling node acts as a Home Agent for the mobile node.

According to another embodiment of the invention, said node is one of a mobile node and a peer node of the mobile node, with the mobile node having a temporary care-of-address and a fixed home address. The fixed home address is an address owned by a Home Agent. Said XORing operation is performed at the mobile node to translate the home address in outgoing IP packet headers to the care-of-address and vice versa for incoming packets, and is performed at the peer node to translate the care-of-address in incoming IP packet headers to the home address and vice versa for outgoing packets.

Preferably, the node comprises means for generating said pad. This means may be arranged to XOR the original header with the intended translation result to generate said pad. Where the header comprises a plurality of parts requiring translation, the means performs the XOR for each part. The means may build the pad by inserting the XOR results into the pad at appropriate locations, and inserting zeros at locations not requiring translation.

According to a second aspect of the present invention there is provided a method of performing an IP packet header translation, the method comprising XORing the packet header or a part thereof with a pad.

According to one embodiment, the XORing results in translation of one or more addresses within the header, for example a source address and/or destination address.

According to a third aspect of the present invention there is provided a node arranged in use to communicate with a peer node over an IP network, the node comprising:
means for generating or receiving IP packets, each packet header comprising a first source address and a first destination address, wherein said first source address is a fixed home address of the node and said first destination address is an address of said peer node;
means for translating said first source address and said first destination address into a second source address and a second destination address respectively, wherein said second source address is a care-of-address of the node and said second destination address is an address of a tunnelling node within said IP network; and means for sending the packet over said IP network.

The node will preferably comprise means for receiving IP packets sent by said peer node over the IP network, and means for translating said second source address and said second destination address into said first source address and said first destination address respectively.

Embodiments of the present invention allow the node to omit an inner IP header from packets sent to the tunnelling node, and similarly allow the tunnelling node to omit the inner header from packets sent to the node.

The or each means for translating preferably comprises means for XORing the header of a packet with a pad. The pad may be generated by XORing the first source address with the second source address, XORing the first destination address with the second destination address, and combining the two results so that the pad maps to an IP header. Bits of the pad mapping to bits of the header other than the source and destination addresses may be set to zero.

Preferably, the node comprises means for notifying the tunnelling node, of the second source address, i.e. care-of-address, to be used by the node. This notification may take the form of a Binding Update message. This means is arranged to include in the Binding Update, information required by the tunnelling node to generate a copy of said pad. Alternatively, the pad itself may be included in the Binding Update.

Preferably, the node comprises means for negotiating a security association with the tunnelling node, and for encrypting said Binding Update in accordance with the security association.

The present invention is applicable in particular to MIPv6 enabled nodes, where said tunnelling node is a Home Agent, and said fixed home address is an address belonging to the Home Agent.

According to a fourth aspect of the present invention there is provided a method of tunnelling IP packets between a first node and a second node via a tunnelling node, where said first node is located at a care-of-address and has a fixed home address allocated to it with the fixed home address belonging to said tunnelling node, the method comprising:
at said first node, for packets to be sent to said second node, operating on the packet header to translate the home address in the source address field to said care-of-address, and to translate an address of said second node in the destination address field to an address of the tunnelling node; and
at said tunnelling node, performing the reverse translations for packets received from said first node.

The method may further comprise, at said tunnelling node, operating on packets received from said second node to translate the address of the second node in the source address field to said address of the tunnelling node, and to translate said home address in the destination field to said care-of-address. The method further comprises, at said first node, operating on packets received from said tunnelling node to translate the address of the tunnelling node in the source address field to the address of said second node, and to translate said care-of-address in the destination field to said home address.

Preferably, said translations are performed using a pad translation. More particularly, this comprises providing a common pad to the first node and the tunnelling node, and XORing the pad with the header of a received packet, and replacing the header with the result. More preferably, said pad has the same length as the packet header, and contains first and second parameters in the source and destination address fields respectively. Other fields are set to zero by default.

Preferably, the method comprises generating said pad at the first node by XORing said home address with said care-of-address to generate said first parameter, and XORing said second node address with the address of said tunnelling node to generate said second parameter.

Preferably, the method is implemented as part of a MIPv6 procedure, said tunnelling node being a Home Agent for said first node. The method comprises including in a Binding Update message sent from said first node to said Home Agent, information required by the Home Agent to replicate said pad. This information may comprise said first and second parameters.

### BRIEF DESCRIPTION OF THE DRAWINGS

FIG. 1 illustrates schematically an IP network employing MIPv6 with bidirectional tunnelling mode;

FIG. 2 is a flow diagram illustrating IP header translation performed at a mobile node and at a Home Agent within the network of FIG. 1;

FIG. 3 illustrates schematically a node implementing a pad translator; and

FIG. 4 illustrates schematically an XORing operation which translates between IP routing headers.

### DETAILED DESCRIPTION

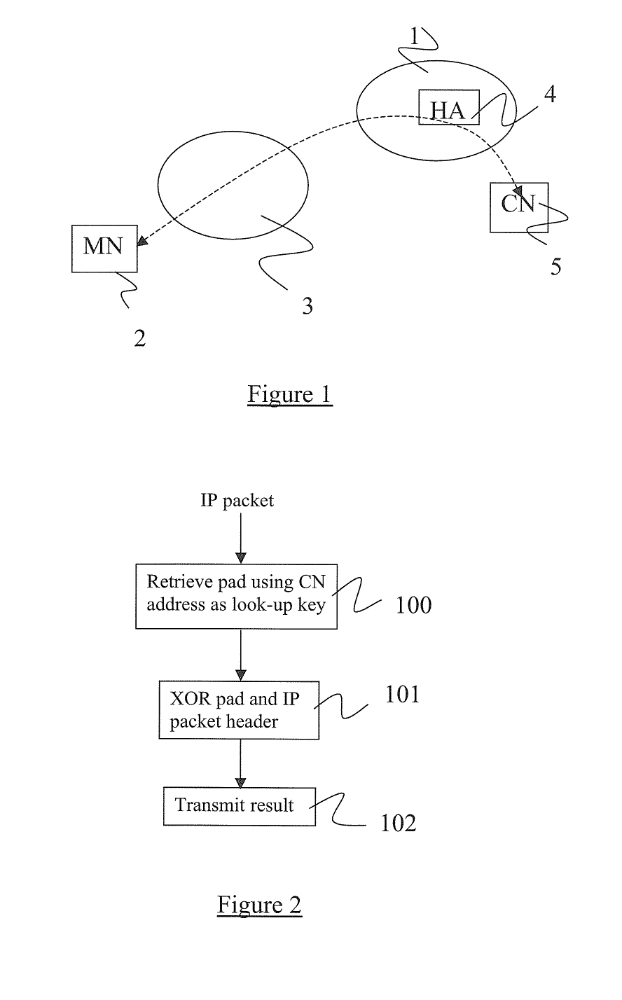

There is illustrated in FIG. 1 a typical communication system which facilitates use of MIPv6. The system comprises a network 1 which represents a home network for a mobile subscriber using a mobile terminal or mobile node (MN) 2. The mobile terminal is shown attached to a visited network 3. A Home Agent (HA) 4 within the home network acts as a static routing point for packets sent between the mobile terminal 2 and any correspondent nodes (one of which is shown in FIG. 1 and identified by reference numeral 5).

MIPv6 uses the IPSec suite of protocols to establish an Encapsulating Security Payload (ESP) security association (SA) between a mobile node and the Home Agent. This SA is used to secure binding update (BU) messages sent from the mobile node to the Home Agent (IPSec is used in “transport” mode). As has already been discussed above, conventional MIPv6 results in the addition of an outer header in data packets sent between the mobile node and the Home Agent and destined for a correspondent node. It is proposed here to introduce a modification to MIPv6 which makes the additional header unnecessary. A new protocol is implemented and is based upon using a special IP “header pad” to translate incoming IP packets headers to reflect the topologies of the new chosen origin and destination.

In order to better describe the new protocol, we apply it to the bidirectional tunnelling (BT) mode. According to the BT mode, after switching to a visited network, the MN configures a Care-of-Address (CoA) and informs the HA of this address by sending an authenticated BU message. After receiving a binding acknowledgment (BA) message from the HA, the MN starts tunnelling data packets back to its HA. Tunnelling can then take place. It is proposed here to modify the BT procedures as follows.

1. The MN generates a “pad translator”. A pad translator is a data string which maps to an IPv6 header, thus having at least two 128-bit parameters. The two 128-bit parameters occupy the IPv6 source address field (Source Translator Parameter or STP) and destination address field (Destination Translator Parameter or DTP) locations. The STP and DTP are derived by the MN as follows,

Source Translator Parameter (STP)=CoA XOR HoA

Destination Translator Parameter (DTP)=HA XOR CN

Other fields of the pad are filled with zeros.

A pad is generated for each CN with which the MN is communicating. The pads are stored in a look-up table which may be addressed, for example, using the CN address.

2. After generating the pad translator at the MN, the MN sends a BU message to its HA to request a binding between its home address and its new (claimed) CoA. The BU message also serves to request the HA to generate a corresponding pad translator (CPT). For this purpose, the MN includes in the BU, within a new option called “translator option” (TO), translator parameters which are used by the HA to build the CPT such that the CPT is identical to the pad translator generated by the MN. These parameters are the STP and the DTP. The BU message is protected by the previously negotiated ESP security association, so the translator parameters are not visible to third parties eavesdropping on communications between the MN and the HA. [Rather than the STP and the DTP, the TO option may contain the address of the CN, allowing the HA to build the pad itself.]

3.When the HA receives the BU, it firstly authenticates the BU (using the conventional procedure), and secondly creates a Binding Cache Entry (BCE) entry for the MN in order to bind the MN's claimed CoA to the MN's home address (HoA). The HA then builds the MN's CPT. This requires that the HA copy the first 128-bit parameter carried in the source address field of the TO into the source address field of the CPT, and the remaining 128 bits of the TO into the destination address field of the CPT, setting all other bits to zero. The MN's CPT is added to the MN's BCE by the HA. The HA then sends a BA message to the MN.

4. After receiving a valid BA message, the MN starts applying the pad translator to data packets to be sent to the CN via its HA. More specifically, the MN applies the pad translator to the (inner) headers of packets received from higher IP layers as follows (again, bits set to zero by default are omitted):

{HoA, CN} XOR {STP, DTP}={CoA, HA}

When the HA receives these packets, it applies the CPT to the headers to reverse the previous translations, i.e.:

{CoA, HA} XOR {STP, DTP}={HoA, CN}

When the HA receives a packet from the CN, it performs the following:

{CN, HoA} XOR {DTP, STP}={HA, CoA}

Whilst, upon receipt of a packet from the HA, the MN performs the following:

{HA, CoA} XOR {DTP, STP}={CN, HoA}

Whilst it is likely that the pad translator is applied only to the header, it may also be applied to the whole packet, with zeros being inserted into the pad at locations corresponding to non-header locations.

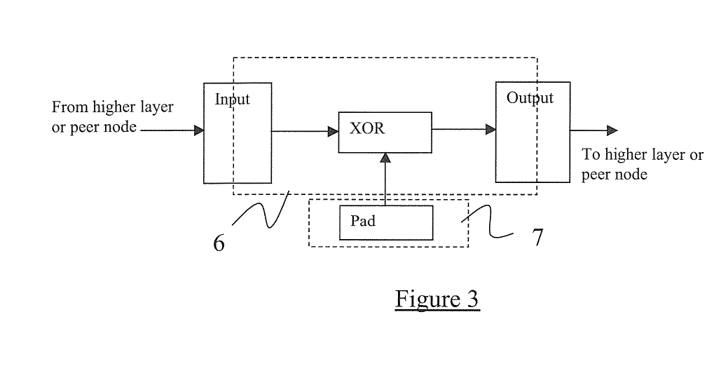

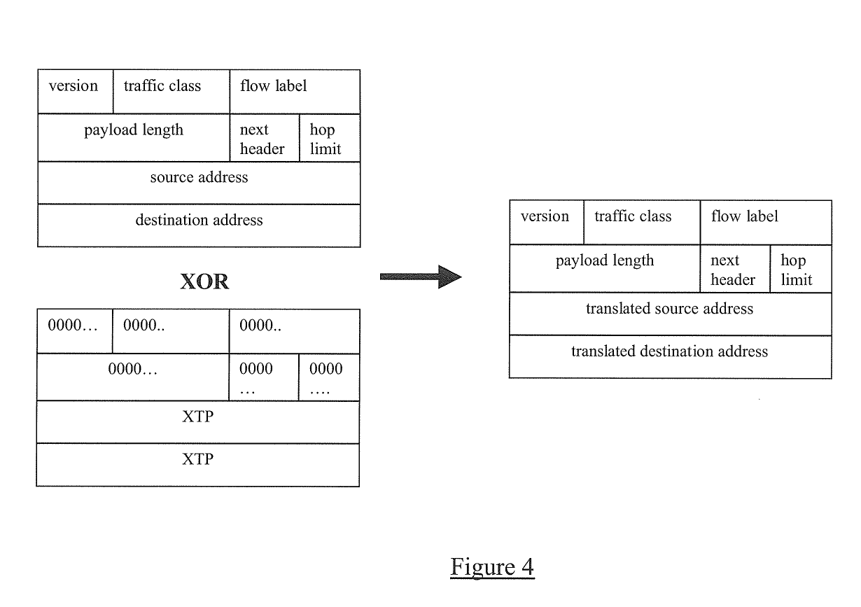

The translation process is illustrated generically by the flow diagram of FIG. 2, whilst FIG. 3 illustrates schematically a node implementing a pad translator by way of a microprocessor 6 and memory 7. The translation process is illustrated further in the schematic of FIG. 4, where the DTP and STP are identified generically as “XTP”.

Care should be taken however to ensure that translation is implemented at the correct stages. More particularly, when the MN receives a data packet from the HA, the MN must start the processing by XORing the packet header with its pad translator. On the other hand, when the MN is sending data packets to the CN (i.e., through the HA), the pad translator is applied to the packet header as the last step to be executed before transmitting the packet. On the HA side, the MN's CPT should be applied as a first processing step upon receiving any data packet from the MN or the CN.

It will be appreciated that, each time the MN switches to a new network, it must refresh its own pad translator and inform its HA about the new parameters needed to refresh the corresponding pads, using a BU message with appropriate TO.

Using a pad translator to eliminate the IP tunnelling is in fact an encryption of the current header which provides a known result. Such translation does not generate nor amplify any new or existing security threats.

It will be appreciated by the person of skill in the art that various modifications may be made to the above described embodiments without departing from the scope of the present invention. For example, XOR is only one example of an involutable function (i.e. a function which when applied twice to a value returns the original value), and other involutable functions may be employed instead. In yet another alternative embodiment, the translations at the MN and at the CN may be achieved by simple substitution, i.e. using look-up tables mapping the inner header to the outer header, with the MN sending to the HA the required mapping data in a BU message. However, this approach may be less efficient than the use of a translation function, and in particular use of an XOR function, as substitution is more computationally intensive than application of a function.

The header translation process described above may be applied to headers other than the IPv6 header, and for which tunneling is applied. For example, it may be desireable to tunnel packets based upon TCP headers, or based upon any layer above the IP layer.

Considering now the route optimisation (RO) mecahnism provided by MIPv6, this allows data packets to be exchanged directly between the MN and the CN (i.e., without going via the HA). All data packets sent by the CN to the MN will have the MN's CoA as destination address and the CN's IP address as source address. MIPv6 has defined a new routing header called “Routing Header type 2” which will contain the MN's home address (HoA) so that the CN will include this in each data packet sent to the MN. In addition, each time the MN sends a data packet to the CN, it uses the MN's CoA as source address and the CN's IP address as destination address as well as adding its own HoA in the “Home Address Option” (HAO) which is carried by the destination option extension header. The pad-based tunnelling optimisation approach described above allows also the MN and the CN to avoid using the HAO and the Routing Header type 2.

This is achieved by generating a pad which can be used to convert between the HoA and the CoA and providing the pad to both the MN and the CN.

1. A node arranged in use to communicate over an IP network, the node comprising:
means for receiving an IP packet either from a peer node or from a higher protocol layer within the node;
means for XORing a header of the packet or part thereof with a pad to translate the header or part thereof; and
means for sending the packet to a peer node or for delivering the packet to a higher protocol layer within the node.

2. A node according to claim 1, wherein said means for XORing effects translation of a source and or destination address of the header.

3. A node according to claim 2, wherein said means for XORing effects translation of a source and or destination address of the header into a routeable address or addresses.

4. A node according to any one of the preceding claims, wherein the node is one of a mobile node and a tunnelling node, packets being routed through the tunnelling node to and from a peer node of the mobile node.

5. A node according to any one of claims 1 to 3, wherein the node is one of a mobile node and a Home Agent, packets being routed through the Home Agent to and from a peer node of the mobile node.

6. A node according to claim 5, wherein said means for XORing is arranged to XOR a header of the packet or part thereof with a pad in order to translate between a care-of-address and a fixed home address of the mobile node.

7. A node according to claim 5 or 6, wherein said means for XORing is arranged to XOR a header of the packet or part thereof with a pad in order to translate between a peer node address and an address of the Home Agent.

8. A node according to claim 1, wherein said node is one of a mobile node and a peer node of the mobile node, with the mobile node having a temporary care-of-address and a fixed home address, the fixed home address being an address owned by a Home Agent, and said means for XORing being arranged to perform an XORing operation in the case of the mobile node to translate the home address in outgoing IP packet headers to the care-of-address and vice versa for incoming packets, and is performed in the case of the peer node to translate the care-of-address in incoming IP packet headers to the home address and vice versa for outgoing packets.

9. A node according to any one of the preceding claims, wherein said pad contains zeros at locations of the header not requiring translation.

10. A node according to any one of the preceding claims and comprising means for generating said pad and means for identifying the pad to a peer or other node.

11. A node according to claim 10, said means for generating the pad being arranged to XOR the original header with the intended translation result to generate said pad.

12. A node according to claim 11 and, where the header comprises a plurality of parts requiring translation, said means for generating the pad being arranged to perform the XOR for each part and build the pad by inserting the XOR results into the pad at appropriate locations, and inserting zeros at locations not requiring translation.

13. A method of performing an IP packet header translation, the method comprising XORing the packet header or a part thereof with a pad.

14. A method according to claim 13, the XORing resulting in translation of one or more addresses within the header into routeable IP addresses.

15. A method according to claim 14, the XORing resulting in translation of a source address and/or destination address.

16. A method of routing IP packets between first and second end points, wherein said first end point has a temporary care-of-address and a fixed home address, the method comprising providing a pad at each of the first and second end point, and XORing the pad with IP packet headers of packets received at and sent from each end point to translate between the care-of-address and the home address within the headers.

17. A method of tunnelling IP packets between a mobile node and a correspondent node via a Home Agent, wherein said mobile node has a temporary care-of-address and a fixed home address owned by the Home Agent, the method comprising providing a pad at each of the mobile node and the Home Agent, and XORing the pad with IP packet headers of packets received at and sent from each of the mobile node and the Home Agent to translate between the care-of-address and the home address and between the Home Agent address and the correspondent node address within the headers.

18. A node arranged in use to communicate with a peer node over an IP network, the node comprising:
means for generating or receiving IP packets, each packet header comprising a first source address and a first destination address, wherein said first source address is a fixed home address of the node and said first destination address is an address of said peer node;
means for translating said first source address and said first destination address into a second source address and a second destination address respectively, wherein said second source address is a care-of-address of the node and said second destination address is an address of a tunnelling node within said IP network; and
means for sending the packet over said IP network.

19. A node according to claim 18 and comprising means for receiving IP packets sent by said peer node over the IP network, and means for translating said second source address and said second destination address into said first source address and said first destination address respectively.

20. A node according to claim 18 or 19, said means for translating comprising means for XORing the header of a packet with a pad.

21. A node according to claim 20, said pad having been generated by XORing the first source address with the second source address, XORing the first destination address with the second destination address, and combining the two results so that the pad maps to an IP header.

22. A node according to claim 21, bits of the pad mapping to bits of the header other than the source and destination addresses being set to zero.

23. A node according to any one of claims 18 to 22, and comprising means for notifying a tunnelling node of the second source address to be used by the node.

24. A node according to claim 23, wherein the means for notifying is a means for sending a binding update.

25. A node according to claim 24, wherein said binding update includes means for generating a pad for use in a pad translation.

26. A method of tunnelling IP packets between a first node and a second node via a tunnelling node, where said first node is located at a care-of-address and has a fixed home address allocated to it with the fixed home address belonging to said tunnelling node, the method comprising:
at said first node, for packets to be sent to said second node, operating on the packet header to translate the home address in the source address field to said care-of-address, and to translate an address of said second node in the destination address field to an address of the tunnelling node; and
at said tunnelling node, performing the reverse translations for packets received from said first node.

27. A method according to claim 26 and comprising, at said tunnelling node, operating on packets received from said second node to translate the address of the second node in the source address field to said address of the tunnelling node, and to translate said home address in the destination field to said care-of-address.

28. A method according to claim 27 and comprising, at said first node, operating on packets received from said tunnelling node to translate the address of the tunnelling node in the source address field to the address of said second node, and to translate said care-of-address in the destination field to said home address.

29. A method according to any one of claims 26 to 28, said translations being performed using a pad translation.

30. A method according to claim 29, said pad translation comprising providing a common pad to the first node and the tunnelling node, and XORing the pad with the header of a received packet, and replacing the header with the result.

31. A method according to claim 30, wherein said pad has the same length as the packet header, and contains first and second parameters in the source and destination address fields respectively with other fields being set to zero by default.

32. A method according to any one of claims 28 to 31 and comprising generating said pad at the first node by XORing said home address with said care-of-address to generate said first parameter, and XORing said second node address with the address of said tunnelling node to generate said second parameter.

33. A method according to any one of claims 28 to 32, the method being implemented as part of a MIPv6 procedure, said tunnelling node being a Home Agent for said first node.

34. A method according to claim 33 and comprising including in a Binding Update message sent from said first node to said Home Agent, information required by the Home Agent to replicate said pad.
